(19) United States
(12) Patent Application Publication
(10) Pub. No.: US 2013/0266053 A1
(43) Pub. Date: Oct. 10, 2013

(54) SIGNAL SELECTING CIRCUIT AND SIGNAL SELECTING METHOD

(71) Applicant: Yuichi Tazaki, Tokyo (JP)

(72) Inventor: Yuichi Tazaki, Tokyo (JP)

(73) Assignee: NEC Corporation, Tokyo (JP)

(21) Appl. No.: 13/991,518

(22) PCT Filed: Dec. 6, 2011
(86) PCT No.: PCT/JP2011/006814

§ 371 Date: Jun. 4, 2013

(30) Foreign Application Priority Data
Dec. 16, 2010 (JP) 2010-280307

(51) Int. Cl. H04L 7/00

(52) U.S. Cl. CPC H04L 7/0037
USPC 375/224

(57) ABSTRACT

A signal selecting circuit according to the present invention includes an abnormality detection circuit that detects an abnormality of the signal input as the main signal in an input stage, a select circuit that selects and outputs the signal input as the main signal among the plurality of signals in the normal state, and when the abnormality detection circuit detects an abnormality of the signal input as the main signal, selects and outputs the signal input as the reserve signal, and a delay circuit that delays the signal input as the main signal by a delay time and outputs the delayed signal to the select circuit, the delay time being equal to or greater than a total time of a detection time in the abnormality detection circuit and a signal switching time in the select circuit.

### TECHNICAL FIELD

The present invention relates a signal selecting circuit and a signal selecting method.

### BACKGROUND ART

There is a type of PLL (Phase Locked Loop) circuit that includes a VCO (Voltage controlled Oscillator) and an APC (Automatic Power Control) circuit that controls an APC signal for the VOC. An example of such a PLL circuit is disclosed in Patent literature 1. In such PLL circuits, the APC circuit controls the VOC so that a clock signal whose frequency is in synchronization with a clock signal supplied from a clock source is generated and output.

Further, in a PLL circuit having a VCO and an APC circuit as described above, it is possible to continue to generate a clock signal even when the supply of the clock signal from the clock source is stopped. That is, in a PLL circuit having a VCO and an APC circuit, it is possible to equip the PLL circuit with a holdover function that makes it possible to continue to generate a signal even when the supply of a base signal is stopped. In a PLL circuit equipped with a holdover function, when the supply of a clock signal from a clock source is stopped due to a failure of the clock source or the like, the APC circuit retains the frequency of the clock signal that was being supplied immediately before the supply of the clock signal is stopped. The VCO generates and outputs a clock signal based on the frequency retained by the APC circuit.

However, in such PLL circuits, there is a problem that since it is necessary to use a circuit(s) including a large number of components such as a VCO and an APC circuit that controls the synchronization of the VCO, the circuit size increases.

Patent literature 2 discloses an uninterrupted clock switching apparatus including a delay circuit and a comparison/selection circuit. The delay circuit generates n clock signals having different phases based on a base clock signal. The comparison/selection circuit selects an output of the delay circuit whose phase is closer to a selected clock signal of another system than any other output of the delay circuit. It is stated in Patent literature 2 that according to this uninterrupted clock switching apparatus, even if the phase difference between clock signals of the two systems is large, the clock signal can be switched without causing any instantaneous interruption.

### CITATION LIST

### Patent Literature

Patent literature 1: Japanese Unexamined Patent Application Publication No. 2003-209468
Patent literature 2: Japanese Unexamined Patent Application Publication No. 10-240375

### SUMMARY OF INVENTION

### Technical Problem

As a method for solving the problem explained above in Background Art, i.e., the problem that the circuit size increases, it is conceivable to adopt a method in which among a plurality of redundant clock sources, a clock signal output from a properly-operating clock source is selected and supplied to a PLL circuit so that the generation of a clock signal in the PLL circuit can be continued. That is, it is conceivable to adopt a method in which when a clock source breaks down and a clock interruption in a clock signal supplied from that clock source is detected, the clock signal is switched so that a clock signal from another clock source is supplied to a PLL circuit. According to this method, it is possible to continue to supply a clock signal to a PLL circuit by using a simple circuit that switches the clock signal supplied to the PLL circuit. That is, there is no need to use a VCO and an APC circuit in a PLL circuit in order to equip the PLL circuit with a holdover function.

However, when the above-described method is adopted, in reality, a certain time period is required from when the stop of a clock signal supply due to a failure of the clock source is detected to when the switching of the clock signal to be supplied to the PLL circuit has been completed. Therefore, there is a problem that no clock signal is supplied to the PLL circuit until the switching of the clock signal has been completed. If an instantaneous interruption occurs in a clock signal supplied to a PLL circuit as described above regardless of whether it is temporary or not, a malfunction, such as outputting a generated clock with an abnormal frequency due to a disengaged lock, occurs in the PLL circuit.

As explained above, there is a problem that in the case where one of a plurality of redundant signals is selected and output, if the signal to be output is switched after detecting an abnormality of the currently-output signal, an instantaneous interruption occurs.

However, Patent literature 2 does not disclose any specific technique that makes it possible to switch the signal without causing any instantaneous interruption even when the signal is switched in response to detection of an abnormality of the currently-output signal.

To solve the problem like the one described above, an object of the present invention is to provide a signal selecting circuit and a signal selecting method capable of, even when a signal that is selectively output from among a plurality of redundant signals is switched in response to detection of an abnormality of the currently-output signal, switching the signal without causing any instantaneous interruption.

### Solution to Problem

A signal selecting circuit according to a first aspect of the present invention is a signal selecting circuit that receives an arbitrarily-selected signal among a plurality of externally-supplied signals as a main signal and another signal as a reserve signal, and selects and outputs the main signal in a normal state, the signal selecting circuit including: an abnormality detection circuit that detects an abnormality of the signal input as the main signal in an input stage; a select circuit that selects and outputs the signal input as the main signal among the plurality of signals in the normal state, and when the abnormality detection circuit detects an abnormality of the signal input as the main signal, selects and outputs the signal input as the reserve signal; and a delay circuit that delays the signal input as the main signal by a delay time and outputs the delayed signal to the select circuit, the delay time being equal to or greater than a total time of a detection time in the abnormality detection circuit and a signal switching time in the select circuit.

A signal selecting method according to a second aspect of the present invention includes: receiving an arbitrarily-selected signal among a plurality of externally-supplied signals as a main signal and another signal as a reserve signal, selecting and outputting, in a select circuit, the signal input as the main signal among the plurality of signals in a normal state, and when an abnormality of the signal input as the main signal is detected in an input stage, selecting and outputting the signal input as the reserve signal; delaying at least the signal input as the main signal by a delay time and outputting the delayed signal to the select circuit, the delay time being equal to or greater than a total time of a detection time for detecting an abnormality in the input stage and a switching time from the main signal to the reserve signal.

### Advantageous Effects of Invention

According to each of the above-described aspects of the present invention, it is possible to provide a signal selecting circuit and a signal selecting method capable of, even when a signal that is selectively output from among a plurality of redundant signals is switched in response to detection of an abnormality of the currently-output signal, switching the signal without causing any instantaneous interruption.

### BRIEF DESCRIPTION OF DRAWINGS

FIG. 1 is a configuration diagram of a signal selecting circuit according to an exemplary embodiment of the present invention;

FIG. 2 is a configuration diagram of a clock transmitting/receiving system according to an exemplary embodiment of the present invention; and

FIG. 3 is a configuration diagram of a clock receiving system according to an exemplary embodiment of the present invention.

### DESCRIPTION OF EMBODIMENTS

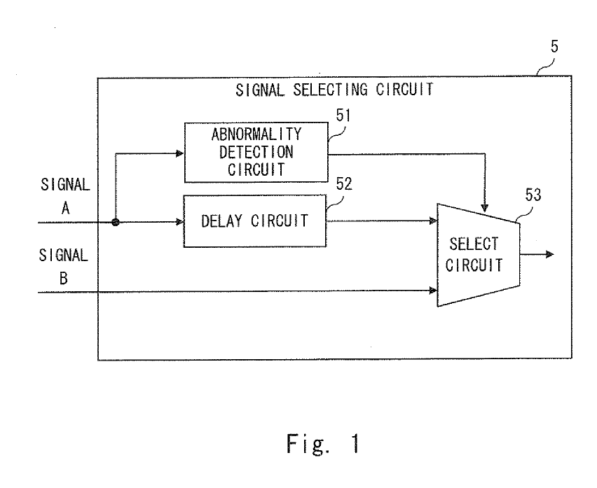

Firstly, a signal selecting circuit 5, which represents an outline of a clock switching circuit according to an exemplary embodiment of the present invention, is explained with reference to FIG. 1. FIG. 1 is a configuration diagram of a signal selecting circuit 5 according to an exemplary embodiment of the present invention.

The signal selecting circuit 5 includes an abnormality detection circuit 51, a delay circuit 52, and a select circuit 53. The signal selecting circuit 5 receives an arbitrarily-selected signal among a plurality of externally-supplied signals as a main signal and receives another signal as a reserve signal. The signal selecting circuit 5 selects and outputs the main signal in a normal state.

The abnormality detection circuit 51 detects an abnormality of the signal input as the main signal in an input stage.

The delay circuit 52 delays the signal input as the main signal by a delay time that is equal to or greater than the total time of a detection time in the abnormality detection circuit 51 and a signal switching time in the select circuit 53, and outputs the delayed signal to the select circuit 53.

The select circuit 53 selects and outputs the signal input as the main signal among the plurality of signals in the normal state. Further, when the abnormality detection circuit 51 detects an abnormality of the signal input as the main signal, the select circuit 53 selects and outputs the signal input as the reserve signal.

Next, processing performed by the signal selecting circuit 5 according to an exemplary embodiment of the present invention is explained. A case where a signal A and a signal B are supplied as the plurality of externally-supplied signals to the signal selecting circuit 5 is explained hereinafter. However, the number of signals that are externally supplied to the signal selecting circuit 5 is not limited to the number used in this example. A case where the signal A and B are input as the main signal and the reserve signal respectively is shown hereinafter as example.

The select circuit 53 selects and outputs the signal A input as the main signal among the signals A and B in a normal state. Note that the delay circuit 52 delays the signal A input as the main signal by a delay time that is equal to or greater than the total time of a detection time in the abnormality detection circuit 51 and a signal switching time in the select circuit 53, and outputs the delayed signal to the select circuit 53.

The abnormality detection circuit 51 detects an abnormality of the signal A input as the main signal in an input stage. When the abnormality detection circuit 51 detects an abnormality of the signal A input as the main signal, the select circuit 53 selects and outputs the signal B input as the reserve signal.

The signal selecting circuit 5 explained above is configured so that the delay circuit 52 delays the signal A input as the main signal by a delay time that is equal to or greater than the total time of a detection time in the abnormality detection circuit 51 and a signal switching time in the select circuit 53, and outputs the delayed signal to the select circuit 53. Therefore, when the abnormality detection circuit 51 detects an abnormality of the signal A input as the main signal, the select circuit 53 can continue to output the signal A input as the main signal until the select circuit 53 selects and outputs the signal B input as the reserve signal. Therefore, according to the above-described signal selecting circuit 5, even when the signal that is selectively output from among a plurality of redundant signals is switched in response to detection of an abnormality of the currently-output signal, it is possible to switch the signal without causing any instantaneous interruption.

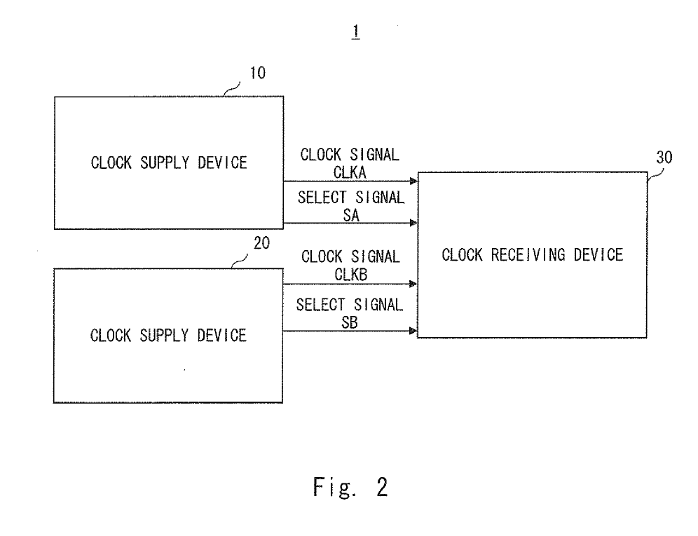

Next, a configuration of a clock transmitting/receiving system 1 according to an exemplary embodiment of the present invention is explained with reference to FIG. 2. FIG. 2 is a configuration diagram of a clock transmitting/receiving system 1 according to an exemplary embodiment of the present invention.

The clock transmitting/receiving system 1 includes clock supply devices 10 and 20, and a clock receiving device 30. The clock supply devices 10 and 20 have a redundant configuration.

Each of the clock supply devices 10 and 20 is a device that supplies a clock signal to the clock receiving device 30. The clock supply device 10 transmits a clock signal CLKA to the clock receiving device 30. The clock supply device 20 transmits a clock signal CLKB to the clock receiving device 30. The clock signals CLKA and CLKB serve as an operation basis for the clock receiving device 30. Further, the clock supply device 10 transmits a select signal SA to the clock receiving device 30. The clock supply device 20 transmits a select signal SB to the clock receiving device 30.

The clock receiving device 30 operates by using a clock signal transmitted from the clock supply device 10 or the clock supply device 20. The clock receiving device 30 determines which of the clock signals CLKA and CLKB transmitted from the clock supply devices 10 and 20 should be used based on the select signals SA and SB transmitted from the clock supply devices 10 and 20 respectively.

The select signals SA and SB are signals that are used to determine which of the clock signal CLKA transmitted from the clock supply device 10 and the clock signal CLKB transmitted from the clock supply device 20 the clock receiving device 30 should use as its operation base clock.

For example, when the clock supply device 10 is in an active state, the clock supply device 20 is in a standby state. The operation states of these clock supply devices 10 and 20 are notified to the clock receiving device 30 by the select signals SA and SB. In above-described case, the clock receiving device 30 determines that the clock supply device 10 is in an active state based on the logic of the select signals SA and SB and thereby selects the clock signal CLKA as the operation base clock. When the operation system is switched between the clock supply devices 10 and 20, the clock signal SA becomes a standby state from the active state and the clock signal SB becomes an active state from the standby state. As a result, the clock receiving device 30 selects the clock signal CLKB as a new operation base clock so as to follow the logic change of the select signals.

That is, when the select signal SA indicates an active state, the clock signal CLKA is selected as an operation base clock, whereas when the select signal SB indicates an active state, the clock signal CLKB is selected as an operation base clock. In other words, the select signals SA and SB are signals that are used to select the signal to be used as the operation base clock in a normal state.

For example, when the clock supply device 10 is in an active state and the clock supply device 20 is in a standby state, the select signal SA is at a Low level and the select signal SB is at a High level. For example, when the clock supply device 10 is in a standby state and the clock supply device 20 is in an active state, the select signal SA is at a High level and the select signal SB is at a Low level. Needless to say, the select signal output by an active clock supply device may be at a High level and the select signal output by a standby clock supply device may be at a Low level.

The clock signals CLKA and CLKB are in synchronization with each other in terms of the frequency. The clock signals CLKA and CLKB may have a phase difference therebetween within a certain range in which no clock dropout and no clock interruption as observed from the clock receiving device 30 occur even when the clock signal selected as the operation base clock is switched.

As described above, the clock signals CLKA and CLKB, which are in synchronization with each other in terms of the frequency and whose phase difference is within a certain range, are continuously transmitted to the clock receiving device 30. Therefore, in the clock receiving device 30, no clock dropout and no clock interruption as observed from the clock receiving device 30 occur even when the operation base clock is switched in accordance with the logic of the select signals.

However, when a failure or the like occurs in the active clock supply device and thus the clock supply to the clock receiving device 30 cannot be continued any longer, a clock interruption in the clock signal supplied from the active clock supply device is detected and switching of the standby cock supply device having a redundant configuration into an active state is thereby started in response to the detection of the clock interruption. As a result, a certain time is taken before the switching of the standby cock supply device into the active state has been completed. Therefore, when observed from the clock receiving device 30, a clock interruption occurs in the input clock signal. That is, no operation base clock is supplied to the clock receiving device 30.

As described above, the clock receiving device 30 autonomously switches the operation base clock by detecting a clock interruption in the input clock signal. However, if the clock signal to be selected is switched after detecting a clock interruption, this switching process causes such a state that no clock signal is input to the internal circuit during the period from when the clock interruption is detected to when the switching has been completed. Therefore, as described later, a delay circuit is inserted in a subsequent stage to the clock root, located within the clock receiving device 30 so that no clock interruption occurs for the internal circuit during the period from when the clock interruption is detected to when the clock root is switched. Further, by doing so, as described later, when the internal circuit is a digital PLL, it is possible to reduce the VCO and the APC circuit.

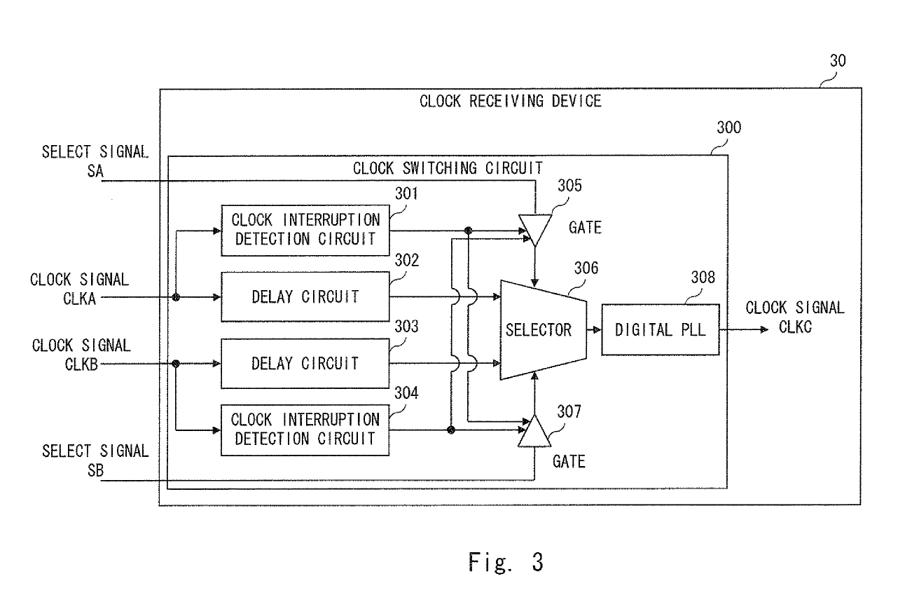

Next, a configuration of the clock receiving device 30 according to an exemplary embodiment of the present invention is explained with reference to FIG. 3. FIG. 3 is a configuration diagram of a clock receiving device 30 according to an exemplary embodiment of the present invention.

The clock receiving device 30 includes a clock switching circuit 300. The clock switching circuit 300 includes clock interruption detection circuits 301 and 304, delay circuits 302 and 303, gates 305 and 307, a selector 306, and a digital PLL 308.

The clock switching circuit 300 operates by using a clock signal output from the clock supply device 10 or 20 as an operation base clock.

The clock interruption detection circuit 301 has a function of detecting a clock interruption in the clock signal CLKA. The clock interruption detection circuit 304 has a function of detecting a clock interruption in the clock signal CLKB. The clock interruption detection circuits 301 and 304 correspond to the abnormality detection circuit 51.

The delay circuit 302 has a function of delaying the clock signal CLKA by a fixed amount. The delay amount is determined in conformity with a protection time that extends until the clock interruption is detected in the clock interruption detection circuit 301. The delay circuit 303 has a function of delaying the clock signal CLKB by a fixed amount. The delay amount is determined in conformity with a protection time that extends until the clock interruption is detected in the clock interruption detection circuit 304. The delay circuits 302 and 303 correspond to the delay circuit 52.

The gate 305 performs gate control for the select signal SA. The gate 307 performs gate control for the select signal SB. The gating condition for the gate 305 is generated by the clock interruption detection circuit 301. The gating condition for the gate 307 is generated by the clock interruption detection circuit 304. When a clock interruption occurs in one of the clock signals, the gates 305 and 307 stop the output of the select signals SA and SB that are directly input to the gates 305 and 307 and output signals that are obtained by switching the logic of the select signal SA and SB.

The selector 306 selects the clock signal to be used as the operation base clock from among the clock signals CLKA and CLKB, which are input to the selector 306 through the delay circuits 302 and 303 respectively. The selecting logic is configured according to the above-described logic of the select signals SA and SB. The gates 305 and 307 and the selector 306 correspond to the select circuit 53.

The digital PLL 308 is a circuit that is implemented in a programable logic device such as a CPLD (Complex Programmable Logic Device) and an FPGA (Field Programmable Gate Array). The digital PLL 308 is an ordinary digital PLL that cannot tolerate any clock interruption in the input clock signal and thus constantly requires the clock input. An example of the digital PLL is an ADPLL (All Digital Phase Locked Loop). In the present invention, the clock signal output from the digital PLL 308 is used as the operation base clock within the clock receiving device 30.

Next, processing performed by the clock switching circuit 300 according to an exemplary embodiment of the present invention is explained with reference to FIGS. 2 and 3.

Assume that, initially, both the clock signals CLKA and CLKB are input to the clock receiving device 30 and the select signals SA and SB indicate an active state and a standby state respectively. At this point, the clock interruption detection circuits 301 and 304 detect no clock interruption in the clock signals CLKA and CLKB respectively and thus do not perform any control on the gates 305 and 307 respectively.

Therefore, the gate 305 outputs the select signal SA transmitted from the clock supply device 10 to the selector 306, and the gate 307 outputs the select signal SB transmitted from the clock supply device 20 to the selector 306. The selector 306 selects the clock signal CLKA as an operation base clock based on the logic condition of the select signals SA and SB output from the gates 305 and 307 respectively, and outputs the selected clock signal CLKA to the digital PLL 308. That is, assume that, in this state, the select signal SA indicates an active state and the select signal SB indicates a standby state.

Meanwhile, each of the delay circuits 302 and 303 delays the respective one of the clock signals CLKA and CLKB transmitted from the clock supply devices 10 and 20 respectively by a fixed amount. Assume that the delay time in this example is represented by “X”. Note that the delay time X in each of the delay circuits 302 and 303 is equal to or greater than the total time of a clock interruption detection time in the respective one of the clock interruption detection circuits 301 and 304 and a switching time of the respective one of the gates 305 and 307 by the respective one of the clock interruption detection circuits 301 and 304. For example, a predetermined time is set as the delay time X based on a clock interruption detection time and a switching time that are measured in advance. The delay circuit 302 outputs the delayed clock signal CLKA to the selector 306. The delay circuit 303 outputs the delayed clock signal CLKB to the selector 306.

As a result, a clock signal CLKA that has been delayed by the total time of the delay time X and the delay time in the selector 306 is input to the digital PLL 308. The digital PLL 308 generates a clock signal CLKC that is obtained by reproducing the clock signal CLKA. The digital PLL 308 outputs the generated clock signal CLKC to each circuit (not shown) within the clock receiving device 30.

In the normal operating state, the clock signals CLKA and CLKB cause no clock interruption. Therefore, the selector 306 switches the clock signal for the digital PLL 308 by switching the clock root to be selected in accordance with the logic change of the select signals SA and SB. Note that the digital PLL 308 is an ordinary digital PLL. Therefore, if an instantaneous interruption occurs in the input clock signal, the frequency of the clock signal CLKC output from the digital PLL 308 cannot be ensured.

Note that even if the active-state clock supply device breaks down due to some reason, the clock signal switching operation is performed in an equivalent fashion to the one that is performed in the normal operating state as observed from the clock receiving device 30 side if the logic of the select signal SA can be switched from the active state to a standby state before the clock signal supply to the digital PLL 308 of the clock receiving device 30 is stopped. In that case, the situation that no clock signal is input to the digital PLL 308 cannot occur. However, there is a possibility that a failure that makes the clock supply device 10 not be able to supply the clock signal CLKA occurs abruptly. To cope with this problem, this exemplary embodiment can make it possible to prevent the clock signal supply to the digital PLL 308 from being stopped until the logic of the select signals SA and SB is switched and the clock signal is supplied from the clock supply device that has been in the standby state until that moment by using the above-described delay circuit 302.

Firstly, when a failure like this occurs in the active clock supply device 10 and the supply of the clock signal CLKA is stopped, the clock supply device 10 detects a clock interruption in the clock interruption detection circuit 301. When the clock interruption detection circuit 301 detects the clock interruption in the clock signal CLKA, the clock interruption detection circuit 301 outputs a clock interruption detection notification signal for notifying the clock interruption detection to the gates 305 and 307. When the clock interruption detection notification signal is output from the clock interruption detection circuit 301, the gate 305 changes the select signal SA to be output to the selector 306 from the active state to a standby state. When the clock interruption detection notification signal is output from the clock interruption detection circuit 301, the gate 307 changes the select signal SB to be output to the selector 306 from the standby state to an active state.

The selector 306 changes the clock root from the clock signal CLKA to the clock signal CLKB in accordance with the logic change of the select signals SA and SB. At this point, as described above, the delay time of the clock signal CLKA in the delay circuit 302 is set so that the clock signal CLKA is delayed by an amount equal to or greater than the total time of the clock interruption detection time in the clock interruption detection circuit 301 and the control time of the gates 305 and 307. Therefore, the input of the clock signal CLKA to the selector 306 is continued during the period in which the clock interruption is detected in the clock interruption detection circuit 301 and the gates 305 and 307 are thereby controlled. That is, it is possible to switch the clock signal supplied to the digital PLL 308 without causing any instantaneous interruption even when a clock interruption is detected and the clock root is thereby switched by the selector 306.

As explained above, this exemplary embodiment includes the delay circuit 302 that delays the clock signal CLKA input as the main signal by a delay time that is equal to or greater than the total time of the detection time in the clock interruption detection circuit 301 and the clock signal switching time in the selector 306, and outputs the delayed clock signal to the selector 306. According to this configuration, it is possible to continue to supply the clock signal CLKA to be supplied to the digital PLL 308 during the period from when an abnormality of the clock signal CLKA is detected by the clock interruption detection circuit 301 to when the switching of the clock signal has been completed. Therefore, even when the clock signal that is selectively output from among a plurality of redundant clock signals is switched in response to detection of an abnormality of the currently-output clock signal, it is possible to switch the clock signal without causing any instantaneous interruption. Further, as a result, it is possible to prevent malfunctions such as disengaged lock from occurring in the digital PLL 308.

Further, in this exemplary embodiment, as described above, even when the clock signal that is selectively output from among a plurality of redundant clock signals is switched in response to detection of an abnormality of the currently-output clock signal, it is possible to switch the clock signal without causing any instantaneous interruption. Therefore, even when an ordinary digital PLL having no holdover function is used, it is possible to continue to generate a clock signal in the digital PLL without causing any malfunction when the clock signal is switched in response to detection of an abnormality of the clock signal. Accordingly, even when a digital PLL is used, it is possible to reduce the circuits such as a VCO and an APC circuit. Note that the clock switching circuit 300 according to this exemplary embodiment is a simpler circuit in comparison to the VCO, the APC circuit, and the like. That is, the circuit size can be reduced.

Further, in this exemplary embodiment, even when a digital PLL is used, it is possible to continue to generate a clock signal in the digital PLL without causing any malfunction when the clock signal is switched in response to detection of an abnormality of the clock signal. Therefore, a PLL can be easily implemented as a digital PLL by using a programable logic device. Accordingly, the cost can be reduced. Note that the clock switching circuit 300 may be entirely implemented by using a programable logic device.

Although the present invention is explained above with reference to exemplary embodiments, the present invention is not limited to the above-described exemplary embodiments. Various modifications that can be understood by those skilled in the art can be made to the configuration and details of the present invention within the scope of the invention.

Although examples in which the present invention is applied to a clock signal are explained in the above-described exemplary embodiments, the signal to which the present invention is applied is not limited to the clock signal. For example, the present invention may be applied to signals in a control bus, signals in a data bus, or the like. By doing so, it is possible to switch those redundant signals without causing any instantaneous interruption. In such cases, for example, an operation circuit that operates by using those signals is implemented in place of the digital PLL.

Although examples in which the clock signal is switched when a clock interruption is detected in the clock interruption detection circuit 301 are explained in the above-described exemplary embodiments, the present invention is not limited to this configuration. The signal may be switched when an abnormality of the signal other than the signal interruption is detected. For example, an abnormality may be detected when the clock signal does not change at regular intervals though the supply of the clock signal is continued.

Although the signal input as the main signal and the signal input as the reserve signal are delayed in the above-described exemplary embodiments, the present invention is not limited to this configuration. It is possible to switch the signal without causing any instantaneous interruption even when only the signal input as the main signal is delayed. For example, assume that the present invention is applied to a clock signal. In this case, if the deviation between the signal input as the main signal and the signal input as the reserve signal that is caused by a delay is handled as a tolerable phase difference such as a simple cyclic deviation, no malfunction occurs in the operation circuit located behind the selector. However, in the case of signals in a control bus or in a data bus, it is preferable that the reserve signal should be also delayed.

Although examples in which the signal supplied to the digital PLL 308 is a clock signal are explained in the above-described exemplary embodiments, the signal supplied to the digital PLL 308 is not limited to the clock signal provided that the signal to be supplied changes periodically. For example, the present invention may be applied to a case where the signal supplied to the digital PLL 308 is a sinusoidal wave.

Although examples in which one signal that is input as the main signal and another signal that is input as the reserve signal are input are explained in the above-described exemplary embodiments, the number of clock signals is not limited to this number. That is, clock signals and select signals may be supplied from three or more clock supply devices. In such cases, the clock receiving device 30 includes three or more clock interruption detection circuits, three or more delay circuits, and three or more gates so that each of them corresponds to a respective one of three or more input signals. Further, when the clock interruption detection circuit detects an abnormality of the clock signal input as the main signal, the selector 306 selects and outputs one of a plurality of clock signals that are input as reserve signals. That is, the gate corresponding to the main signal changes the logic of the select signal to be output to the selector 306 from the active state to a standby state. Further, one of the gates corresponding to the reserve signals may change the logic of the select signal to be output to the selector 306 from the standby state to an active state.

Further, when the clock interruption detection circuit detects an abnormality of the newly-selected clock signal (clock signal input as the reserve signal), the selector 306 may select and output the clock signal input as the main signal or one of clock signals that are input as other reserve signals. That is, the gate corresponding to the newly-selected reserve signal changes the logic of the select signal to be output to the selector 306 from the active state to a standby state. Further, one of the gates corresponding to the main signal and the other reserve signals may change the logic of the select signal to be output to the selector 306 from the standby state to an active state.

Note that the above-described clock switching circuit 300 can be implemented in a network device that operates by using a clock signal output from the clock switching circuit 300, such as a telephone switching device. For example, the clock switching circuit 300 may be provided in a processor card, a switch card, or a similar card, and the card may be installed in a telephone switching device. In such cases, the clock receiving device 30 corresponds to the telephone switching device. For example, a plurality of telephone switching devices are provided in a clock transmitting/receiving system and a clock signal(s) is supplied from a clock supply device to the plurality of telephone switching devices. In this way, the plurality of telephone switching devices may be operated in synchronization with each other.

This application is based upon and claims the benefit of priority from Japanese patent application No. 2010-280307, filed on Dec. 16, 2010, the disclosure of which is incorporated herein in its entirety by reference.

### REFERENCE SIGNS LIST

1 CLOCK TRANSMITTING/RECEIVING SYSTEM
5 SIGNAL SELECTING CIRCUIT
10, 20 CLOCK SUPPLY DEVICE
30 CLOCK RECEIVING DEVICE
51 ABNORMALITY DETECTION CIRCUIT
52, 302, 303 DELAY CIRCUIT
53 SELECT CIRCUIT
300 CLOCK SWITCHING CIRCUIT
301, 304 CLOCK INTERRUPTION DETECTION CIRCUIT
305, 307 GATE
306 SELECTOR
308 DIGITAL PLL

1. A signal selecting circuit that receives an arbitrarily-selected signal among a plurality of externally-supplied signals as a main signal and another signal as a reserve signal, and selects and outputs the main signal in a normal state, the signal selecting circuit comprising:
an abnormality detection circuit that detects an abnormality of the signal input as the main signal in an input stage;
a select circuit that selects and outputs the signal input as the main signal among the plurality of signals in the normal state, and when the abnormality detection circuit detects an abnormality of the signal input as the main signal, selects and outputs the signal input as the reserve signal; and
a delay circuit that delays the signal input as the main signal by a delay time and outputs the delayed signal to the select circuit, the delay time being equal to or greater than a total time of a detection time in the abnormality detection circuit and a signal switching time in the select circuit.

2. The signal selecting circuit according to claim 1, wherein the delay circuit delays the signal input as the reserve signal by the delay time and outputs the delayed signal to the select circuit.

3. The signal selecting circuit according to claim 2, wherein
the abnormality detection circuit detects an abnormality of the signal input as the reserve signal in an input stage, and
when the abnormality detection circuit detects an abnormality of the signal input as the reserve signal in a state where the select circuit selects and outputs the signal input as the reserve signal, the select circuit selects and outputs the signal input as the main signal or a signal input as another reserve signal.

4. The signal selecting circuit according to claim 1, wherein
the signal is a signal that changes at a regular interval, and
the signal selecting circuit further comprises a digital PLL (Phase Locked Loop) that receives a signal output from the select circuit and thereby operates, and has no holdover function.

5. The signal selecting circuit according to claim 4, wherein the digital PLL is a circuit formed in a programable logic device.

6. The signal selecting circuit according to claim 4, wherein the signal is a clock signal.

7. The signal selecting circuit according to claim 1, wherein the delay time is a predetermined fixed time.

8. The signal selecting circuit according to claim 1, wherein the select circuit externally receives a select signal for selecting the signal input as the main signal, and selects and outputs a signal selected by that select signal among the plurality of externally-supplied signals in the normal state.

9. A signal selecting method comprising:
receiving an arbitrarily-selected signal among a plurality of externally-supplied signals as a main signal and another signal as a reserve signal,
selecting and outputting, in a select circuit, the signal input as the main signal among the plurality of signals in a normal state, and when an abnormality of the signal input as the main signal is detected in an input stage, selecting and outputting the signal input as the reserve signal;
delaying at least the signal input as the main signal by a delay time and outputting the delayed signal to the select circuit, the delay time being equal to or greater than a total time of a detection time for detecting an abnormality in the input stage and a switching time from the main signal to the reserve signal.
